(19) United States
(12) Patent Application Publication
(10) Pub. No.: US 2009/0201680 A1
(43) Pub. Date: Aug. 13, 2009

(54) LED and the promptly fabricating material structure and the connect method thereof

(75) Inventors: Hsien-Ching Chang, Taipei (TW); Tzu-Sung Chen, Taichung (TW)

Correspondence Address: SALLY CHANG, 7F, NO. 3, ALLEY 32, SEC. 6 CHUNG-HSIAO EAST RD., TAIPEI, TAIWAN, R.O.C. 115, TAIPEI, 115, TW

(73) Assignee: JOYIN TECHNOLOGY INC.

(21) Appl. No.: 12/318,348

(22) Filed: Dec. 29, 2008

(30) Foreign Application Priority Data
Feb. 12, 2008 (TW) 097202665

(51) Int. Cl. B60Q 1/00

(52) U.S. Cl. 362/249.03

(57) ABSTRACT

An easy-to-assembly LED and substrate providing fast assembling, simple replacement and maintenance, exchangeable arrangement of LED (3) without wiring or welding process comprises:
an assembling substrate (1) having sandwich-like structure, consists essentially of a plurality of conductive layers (10) and a plurality of non-conductive layers (11);
a plurality of LED (3) having at least one lead partially insulated, all conductive sections and insulated sections of said LED (3) will correspond to the arrangement of conductive layers (10) and non-conductive layers (11) of said assembling substrate (1); and
a power source (4).

### FIELD OF THE INVENTION

The present invention relates to an easy-to-assembly Light Emitting Diode (LED) and a substrate for installing said LED.

### DESCRIPTION OF PRIOR ART

To assemble a conventional LED is usually by wiring on the back of the substrate or welding, assemble method usually can be categorized in:
1. Installed on a Printed Circuit Board (PCB), as shown in FIG. 1. A PCB with preset circuit wirings and predetermined positions perforated for the LED, the installation is to dispose the LED into the predetermined holes and securing the anode and cathode lead of said LED on the PCB by welding. Using this method, the arrangements of LEDs are limited by the preset circuit wirings and positioning holes, therefore changing the figure displayed by LEDs becomes a problem.
2. Installed on a substrate without preset circuit wirings. Predetermined positioning holes for LEDs are perforated in advance, after disposing LEDs into the preset positioning holes, connect the anode and cathode lead of each LED with conductive wire and secure by welding, as shown in FIG. 2 or wiring, as shown in FIG. 3. This method possesses the same defect as the first method, the figure is limited by the predetermined holes, it also has defect such as Disconnection or disordered wires when too many LEDs are disposed on the substrate.
3. Lead to lead connection. As shown in FIG. 4, when small quantity of LEDs need to be connected, connecting one lead of the LED to the lead of another can reduce the cost of the conductive wire. Although no preset circuit wirings or positioning holes are requires, connecting each lead by welding will cause problem in future replacement.
4. LED with preset conducting wires connection. As shown in FIG. 5, conductive wires are coupled with LEDs before installation or during manufacture. The installation of LED can be easily done by connecting preset conducting wires, however the position of LED is sometimes limited by the predetermined length of the conducting wires, said method also possesses mentioned problems such as misconnection and disordered conducting wires.

Although described methods have their drawbacks, it won't cause any difficulty for conventional use which required only few LEDs for indication or arranging a specific figure. However, LED becoming the illumination device of next generation is foreseeable, application of LED in consuming or custom product is increasing, LED of different types or colors are usually applied into the same product, mentioned methods will limit the development and popularization of the LED. Complex wiring and special skill required, high cost and misconnection problems plus defect of future maintenance or replacement, therefore a easier or instant assembly LED with convenient assembled structure which can simplify the installation becomes the main objective of the present invention.

### SUMMARY OF THE INVENTION

The present invention relates to a solderless LED and assembling substrate providing instant assembly, fast replacement and interchangeable LED arrangement. Said LED and substrate provide faster LED installation, easy maintenance and replacement, allowing any person with skill or not can arrange the LEDs into the figures, letters or symbols as desired.

An easy-to-assembly LED and substrate, specified in faster LED installation, easy maintenance and replacement comprise:

an assembling substrate (1) having sandwich structure consisting essentially of a plurality of conducting layer (10) and a plurality of non-conductive layer (11);

a plurality of LED (3) having at least one lead is partially insulated, all conductive and insulated sections of said LEDs (3) will match the arrangement of the conductive layers (10) and non-conductive layers (11) of said assembling substrate (1); and

a power source (4).

Said assembling substrate (1) is for disposing the LED (3), the conductive layers (10) are for connecting the conductive point of LED (3) with the power source (4); said assembling substrate (1) is in a sandwich structure having a plurality of conductive layers (10) and a plurality of non-conductive layers (11), said conductive layers (10) can be made of metal net, aluminum foil or conductive fabric, said non-conductive layers (11) can be made of insulating foam, rubber foam or rubber. The assembling substrate (1) can be made into any shape or as specific shape to match a product it can also be made with the primary material of the product to couple with said product directly.

Said LED (3) can be a first type LED (31), having at least one lead not insulated or a second type LED (32). The insulated process of said first type LED (31) can be made by applying an insulated treatment on the surface of the lead and encapsulation molding or a single-pin adapter for a second type LED (32).

Said first type LED (31) as described above is characterized in that each lead has different length and all leads are partially insulated except the first conductive layer lead (311). Said second type LED (32) is characterized in that both single-pin conductive section (321) and single-pin insulated section (322) will match the sandwich-like arrangement of conductive layers (10) and non-conductive layers (11) of the assembling substrate (1). The epoxy encapsulation of said LED (3) can be the shape of a typical cylindrical encapsulation or a special shape such as letter, figure or number.

Said power source (4) as mentioned above can connect electrically with a power connector (2), the conductive and insulated area of said power connector (2) will match the conductive layer (10) and non-conductive layer (11) of the assembling substrate (1); Said conductive layer (10) can be maintain as a single section or divided into plurality of independent sections where each sections can connect with equal or different standards of power source (4). The power connector (2) can connect electrically said power source (4) with said assembling substrate (1), it can also electrically connect one assembling substrate (1) with another.

Said first type LED (31) can be selected from a dual-leads LED (31A) having a first conductive layer lead (311) not insulated and another lead partially insulated or a multi-leads LED (31B) having all leads partially insulated except the first conductive layer lead (311).

Said second type LED (32) can be selected from a single-pin/dual-poles LED (32A), having its single-pin conductive section (321) and single-pin insulated section (322) in sandwich-like arrangement to match the arrangement of conductive layer (10) and non-conductive layer (11) of the assemble substrate (1) or a single-pin/multi-poles LED (32B), having its single-pin conductive section (321) and single-pin insulated section (322) in sandwich-like arrangement to match the arrangement of conductive layer (10) and non-conductive layer (11) of the assembling substrate (1).

An alternative single-pin LED (32C) and alternative single-pin/multi-poles LED are two types of second type LED (32) by using single-pin adapter. The alternative single-pin LED (32C) is formed by connecting a conventional lead LED (33) with a single-pin/dual-poles adapter (34), the single-pin conductive section (321) and single-pin insulated section (322) of said single-pin/dual-poles adapter (34) are arranged in sandwich-like structure and match the arrangement of conductive layer (10) and non-conductive layer (11) of the assemble substrate (1); an alternative single-pin/multi-poles LED consists essentially of a multi-leads LED (31B) with a single-pin/multi-poles adapter, the single-pin conductive section and single-pin insulated section of said single-pin/multi-poles adapter are arranged in sandwich-like structure and match the arrangement of conductive layer (10) and non-conductive layer (11) of the assembling substrate (1).

Moreover, a single-pin SMD LED (32D) is another type of the second type LED (32). A single-pin SMD LED (32D) consists essentially of a single-pin SMD adapter (36), a light shield (37) disposed on top of said single-pin SMD adapter (36) and a SMD LED (35) disposed between said single-pin SMD adapter (36) and light shield (37); the conductive and insulated portion of said single-pin SMD adapter (36) have a sandwich-like structure and match the arrangement of conductive layer (10) and non-conductive layer (11) of the assembling substrate (1).

The conductive point (313) and insulated lead (312) of the LED (3) will match the conductive layer (10) and non-conductive layer (11) of the assembling substrate (1), when a LED (3) is inserted vertically and completely into said assembling substrate (1), the LED (3) will be provided with electricity without wiring or welding. If each conductive layer (10) is provided with sufficient and adequate power, the LED (3) can be lighting and controlled, the connection of the power source (4) is provided by the power connector (2) which possesses similar leads structure as said LED (3).

Furthermore, the assembling substrate (1) provides fast assembly of LED (3), the plurality of conductive layer (10) are for connecting non-insulated lead with power source (4), each conductive layer (10) can be divided into plurality of independent sections for splitting the current and controlling purpose.

Said assembling substrate (1) can be manufactured as any geometry figures, letters, symbols and shapes or a specific shape to match a product, it can also be as primary material of the product. The power which connects with each conductive layer (10) or each independent section can have the same or different voltages; the power also can be synchronous or asynchronous. Therefore LED (3) with different standard, color and encapsulation shape can be applied on the same assembling substrate (1).

The LED (3) having at least one lead partially insulated can prevent the short circuit causing by connecting electrically with inappropriate conductive layer (10), when the LED (3) is inserted into the assembling substrate (1). The type of LED (3) can be selected from a first type LED (31) or a second type LED (32) or other similar types of LED (3). The encapsulation of said LED (3) can be made into a typical cylindrical encapsulation or a special shape such as letter, figure or number.

Comparing with the prior art, the present invention possesses following advantages:
1. By the design of sandwich-like structure of plurality of conductive layers (10) and non-conductive layers (11) of the assembling substrate (1), with characteristic wherein each conductive layer (10) can supply different current allow LEDs (3) with same or different standards can be disposed into the same assembling substrate (1) without complex wiring or welding process, reducing the assembly time and facilitate maintenance or replacement in the future.
2. By using LED (3) having at least one lead partially insulated, the LED (3) can be connected with different standard of power in the same substrate, allowing a user having skill in the art or not can display any letter, figure or number as desired, using different color or standard of LED (3). The invention provides an easy installation of LED (3) with less error and no more complex wirings or welding procedure.
3. A reflecting film or other reflecting device can be applied on the surface of the assembling substrate (1) to intensify the illumination by reflecting the light emitting from the LED (3).
4. The surface of the assembling substrate (1) can be mark out in different sections by printing or materials in different colors to remind the user which type of LED (3) can be installed in specific section.
5. Said assembling substrate (1) can be coupled with a light shield to protect the LED (3) in between. By using light-guiding shield can intensify the illumination of LED (3) and by using the diffuser, the light of LED (3) can display uniformly.
6. Power source (4) connects with a control device (41) allows the user to adjust the brightness of the LED (3) disposed on the assembling substrate (1).
7. The plurality of conductive layer (10) or independent sections of conductive layer (10) can be connected in series arrangement with the current, reducing the joint current or permitting the use of high voltage.

### BRIEF DESCRIPTION OF DRAWINGS

FIG. 1: A schematic view of conventional LED connected electrically by preset circuit wirings.

FIG. 2: A schematic view of conventional LED connected electrically by welding with conductive wires.

FIG. 3: A schematic view of conventional LED connected electrically by winding with conductive wires.

FIG. 4: A schematic view of conventional LED connected electrically by welding the leads.

FIG. 5: A schematic view of conventional LED connected electrically by twisting 2 preset wires of different LEDs together.

FIG. 6: A cross-sectional view of the embodiment of the present invention.

FIG. 7: An exploded view of the assembling substrate of the present invention.

FIG. 8: A cross-sectional view of a dual-leads LED

FIG. 9: A cross-sectional view of a single-pin/dual-poles LED

FIG. 10: A schematic view of the assembling substrate made into an irregular shape.

FIG. 11: A schematic view of the assembling substrate made in a specific shape to match a product

FIG. 12: A schematic view of the assembling substrate as primary material of a product

FIG. 13A: A schematic view of plurality of dual-leads LED having same standard disposing on the same assembling substrate.

FIG. 13B: A cross-sectional view of plurality of dual-leads LED having same standard disposing on the same assembling substrate.

FIG. 14A: A schematic view of plurality of dual-leads LED having different standards disposing on the same assembling substrate.

FIG. 14B: A cross-sectional view of plurality of dual-leads LED having different standards disposing on the same assembling substrate.

FIG. 15: A cross-sectional view of a multi-leads LED and a single-pin/multi-poles LED connected with the assembling substrate.

FIG. 16A: A schematic view of the assembling substrate with conductive layers having plurality of independent sections.

FIG. 16B: A cross-sectional view of the assembling substrate with conductive layers having plurality of independent sections.

FIG. 17: A cross-sectional view of a single pin/dual-poles LED with non-conventional encapsulation.

FIG. 18: A diagrammatic view of a conventional LED plugged into a single pin/dual-poles LED adapter.

FIG. 19: A cross-sectional view of a single-pin SMD LED.

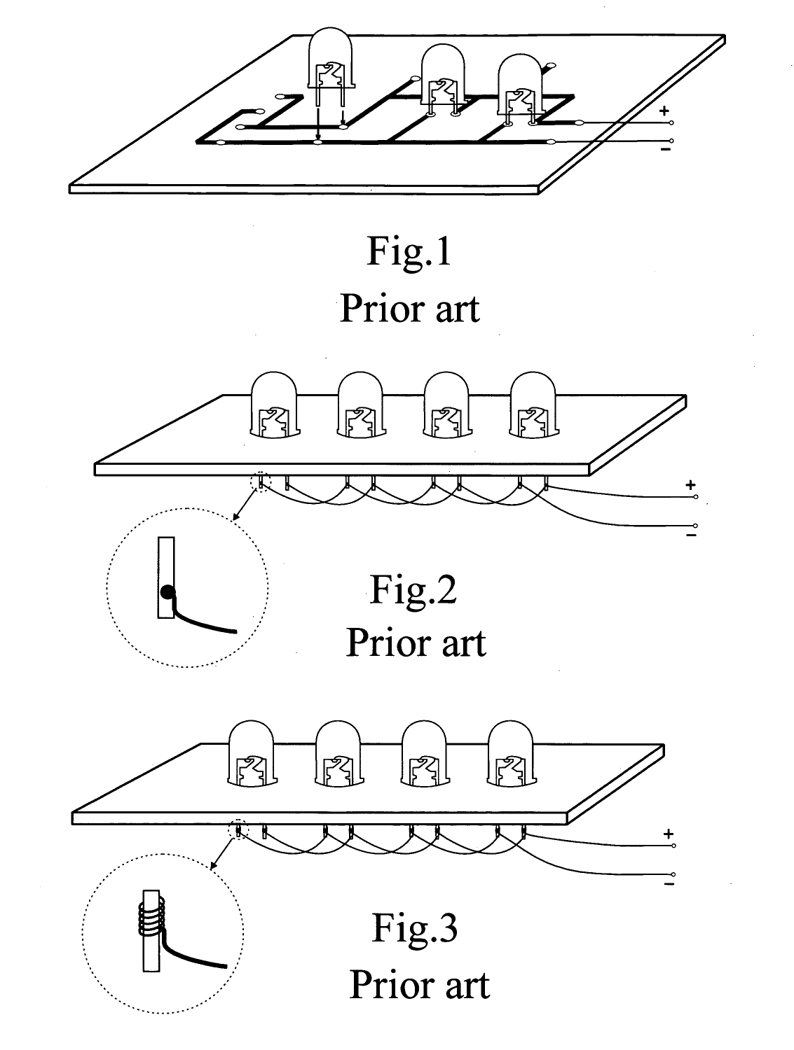

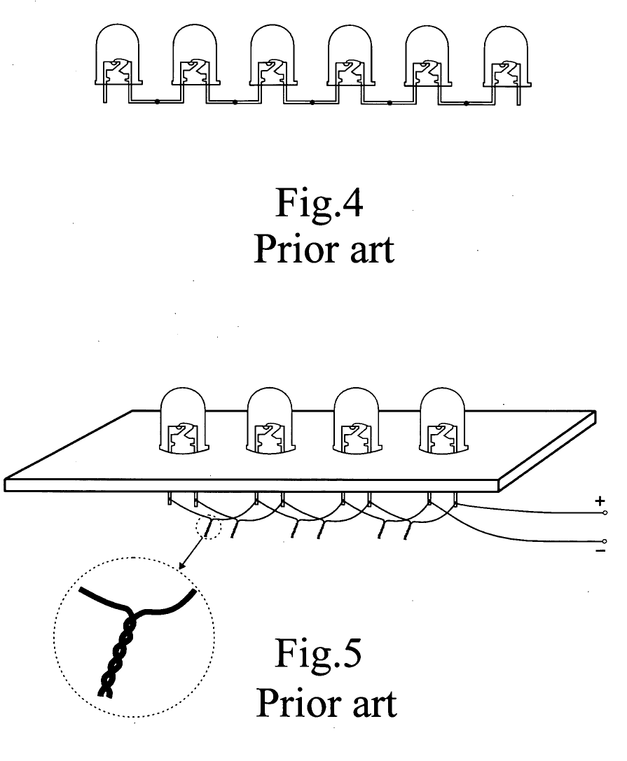

### DETAIL DESCRIPTION OF THE PREFERRED EMBODIMENT

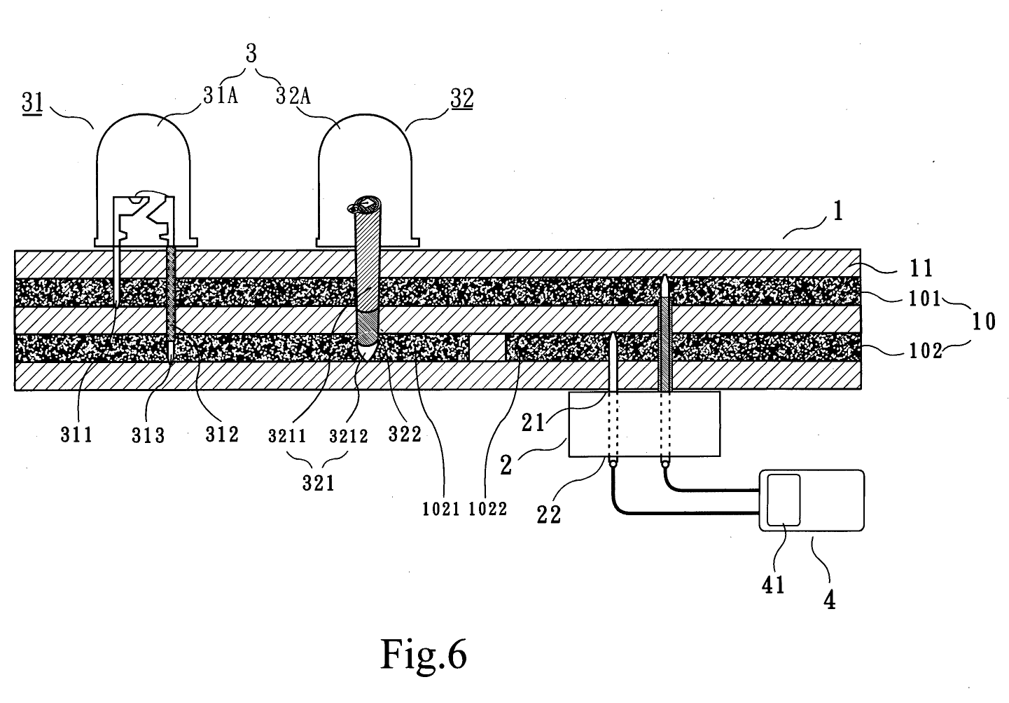

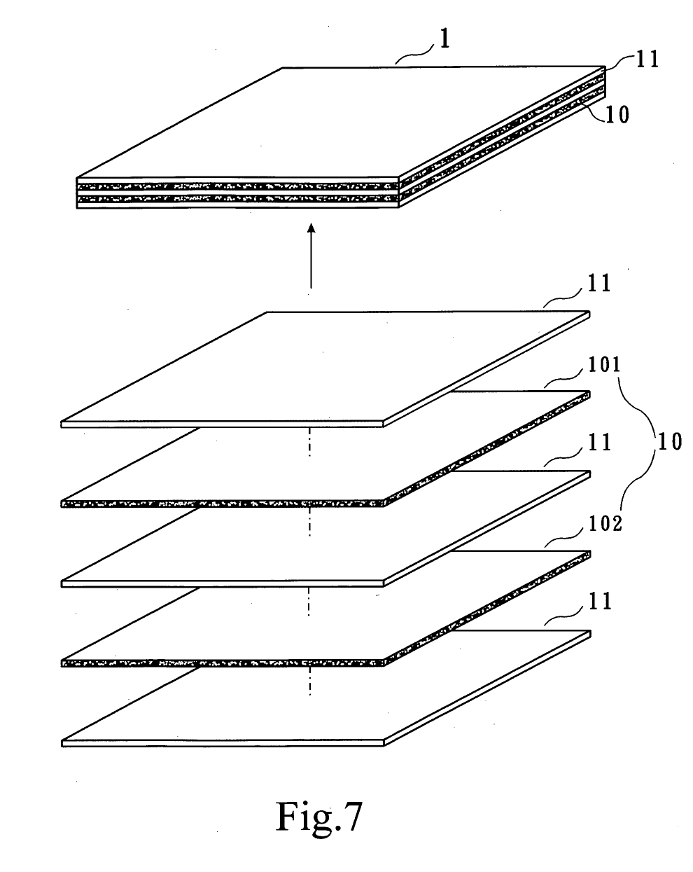

As shown in FIGS. 6-7, an easy-to-assembly LED and substrate comprise:

An assembling substrate (1) having sandwich structure consists essentially of a plurality of conductive layers (10) and a plurality of non-conductive layers (11), connected with a power source (4) through a power connector (2). Therefore, when an east-to-assembly LED is plugged into said assembling substrate (1) it can illuminate instantly.

Said non-conductive layer (11) of the substrate (1) can be made of penetrable insulated material (e.g. insulated foam, rubber foam or rubber etc.), it can also be made of impenetrable insulated material (e.g. plastic or PMMA etc.) with pre-perforated position holes or be made of any material which can provide insulation when the lead of LED (3) passing through.

Said conductive layer (10) can be made of penetrable conductive material (e.g. metal net, aluminum foil or conductive fabric etc.), it can also be made of impenetrable conductive material (e.g. copper or aluminum plate etc.) with pre-perforated position holes. Said conductive layer (10) can be divided into plurality of independent sections. As shown in FIG. 6, sections (1021, 1022) are independent sections of a second conductive layer (102).

A plurality of LED (3) having at least one lead partially insulated, said partially insulated lead will prevent any short circuit when a LED (3) is plugged into the substrate (1) and connected with inappropriate conductive layer (10).

The LED (3) having at least one lead partially insulated can be a first type LED (31) with insulation process on partial of majority of leads, a second type LED (32) or other type of LED (3) having similar character. Said insulation process can be made by applying an insulating treatment on exterior of the lead for the first type LED (31), encapsulation molding or plugged the LED (3) into an adapter for the second type LED (32) (FIG. 18).

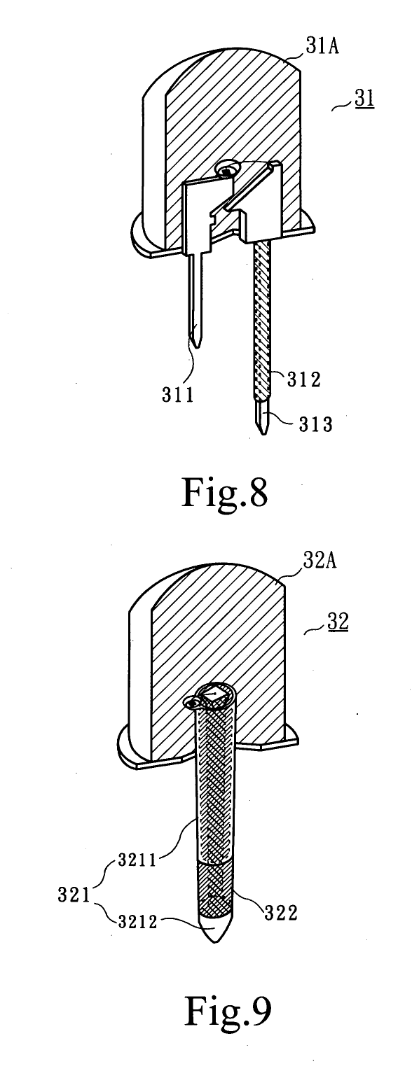

As shown in FIG. 8, an first type LED (31) is characterized in that lengths of all leads are different and all leads are partially insulated except the first conductive layer lead (311). The length of each lead is appropriate to reach its suitable conductive layer (10). As shown in FIG. 6, the length of a first conductive layer lead (311) has an appropriate length to reach the first conductive layer (101) only, to avoid any possibility of short circuit by connecting other conductive layer (10) and the length of an insulated lead (312) has an appropriate length to allow the insulated lead (312) passing all unsuitable conductive layers (10) {e.g. first conductive layer (101)}; a conductive point (313) should contact with a suitable conductive layer (e.g. the second conductive layer (102) in FIG. 6) and the length of said conductive pin (313) should be shorter than the thickness of thinnest non-conductive layer (11) which has penetrated to avoid any short circuit.

As shown in FIG. 9, a second type LED (32) is characterized in that a single-pin conductive section (321) and a single-pin insulated section (322) are arranged in sandwich-like arrangement to match the arrangement of conductive layer (10) and non-conductive layer (11) of the assembling substrate (1). As shown in FIG. 6, the length of the single-pin insulated section (322) allows a single-pin conductive point (3212) to connect with the second conductive layer (102) but not contacting with the first conductive layer (101) to cause a short circuit. A single-pin first conductive section (3211) has a length only to allow the single-pin first conductive section (3211) contacting with the first conductive layer (101) but not contacting the second conductive layer (102). The single-pin conductive point (3212) should contact with a suitable conductive layer (e.g. the second conductive layer (102) in FIG. 6) and the length of said single-pin conductive point (3212) should be shorter than the thickness of thinnest non-conductive layer (11) which has penetrated to avoid any short circuit.

A power source (4) which can electrically connected to a power connector (2) for conducting electricity to the assembling substrate (1); a first connecting area (21) of said power connector (2) has the same lead structure as the LED (3), which it can have one or more partially-insulated lead and a conductive lead as the first type LED (31) or multiple conductive and insulated sections as the second type LED (32). Both lead structures will match the arrangement of conductive layer (10) and non-conductive layer (11) of the assembling substrate (1). Said partially insulated lead and non-insulated lead of the power connector (2) provide fast connection of conductive layer (10) with the power source (4) or an assembling substrate (1) with another. A second connecting area is for connecting the power source (4) and a control device (1), the type of connection is not limited in the embodiment.

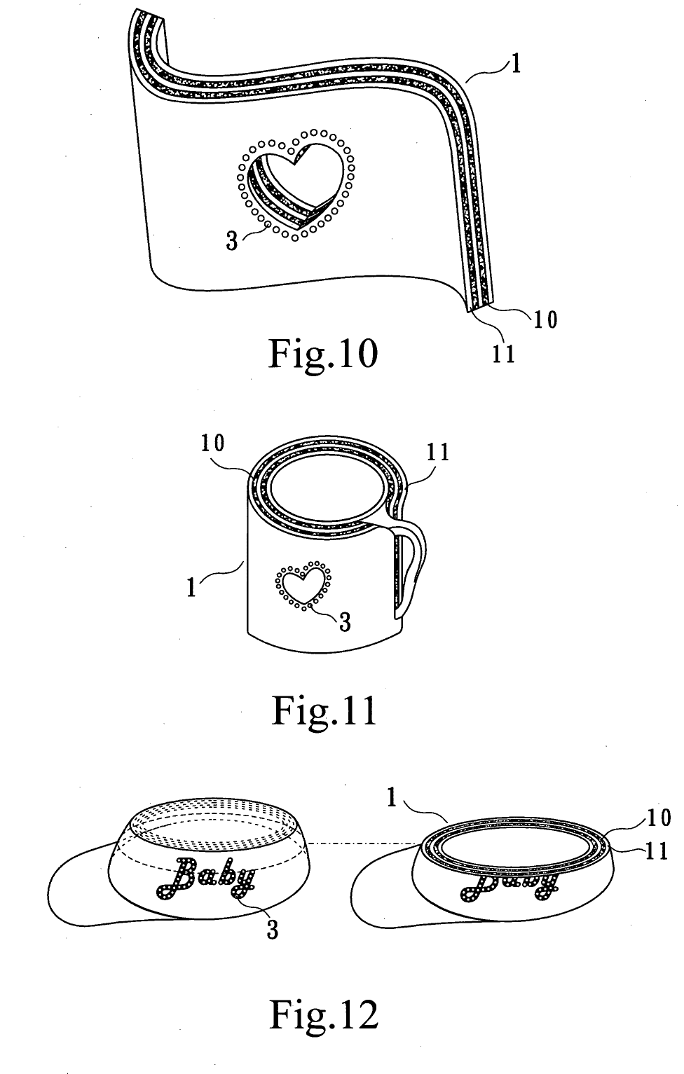

As shown in FIGS. 10-12, the assembling substrate (1) of the present invention can be made into an irregular shape (FIG. 10), to match and be coupled on the surface of a product (FIG. 11) or it can be coupled to a product by being the primary material of said product (FIG. 12).

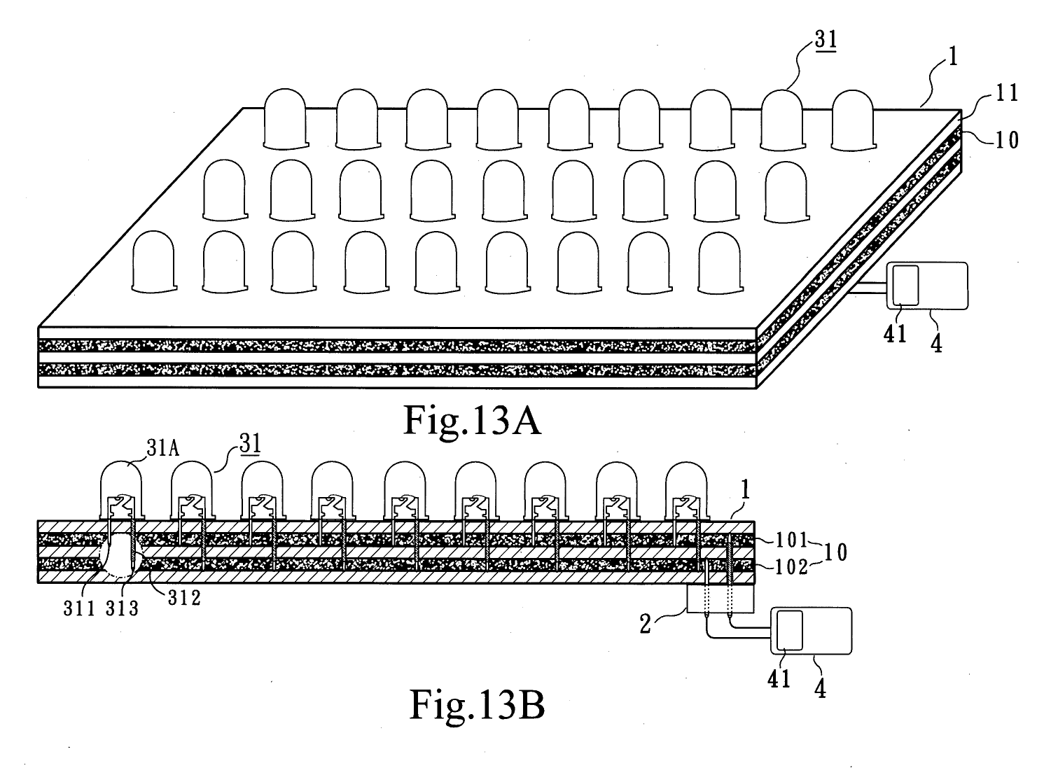

As shown in FIGS. 13A and 13B, a plurality of first type LED (31) are disposing on the assembling substrate (1), the structure and function of each first type LED (31) is the same as disclosed above, by plugging LEDs (3) into the assembling substrate (1) to form desired display and connecting the assembling substrate (1) with power source (4), a figure arranged by LEDs (3) is formed.

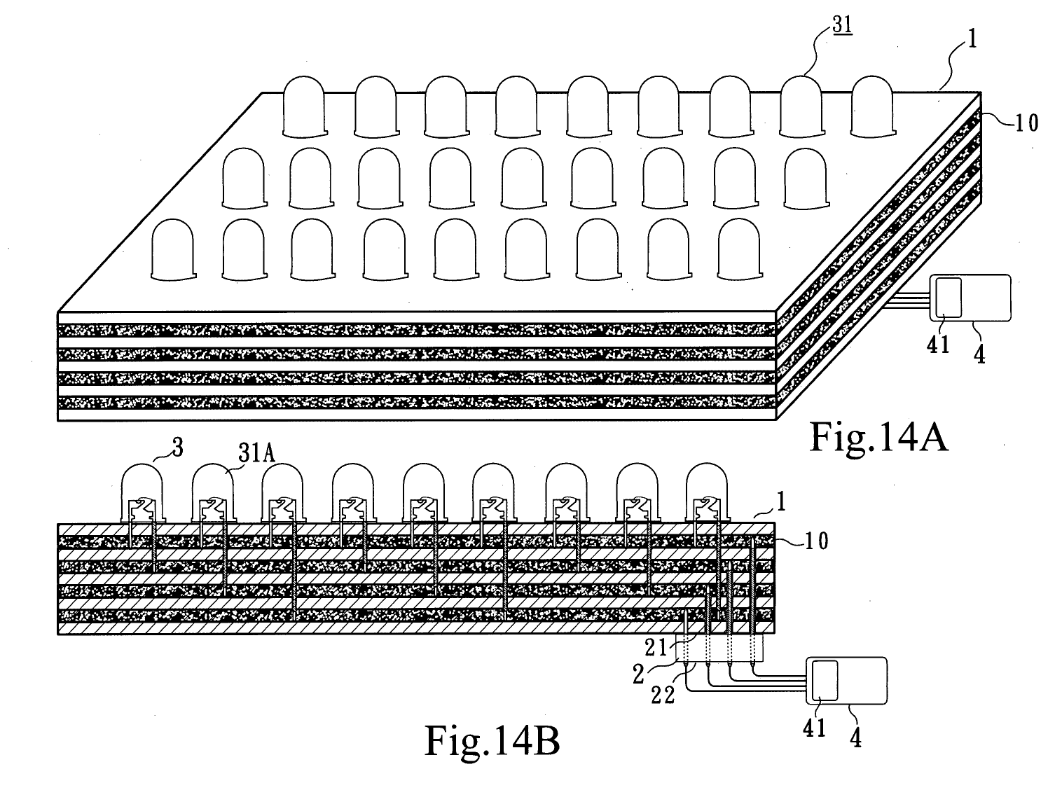

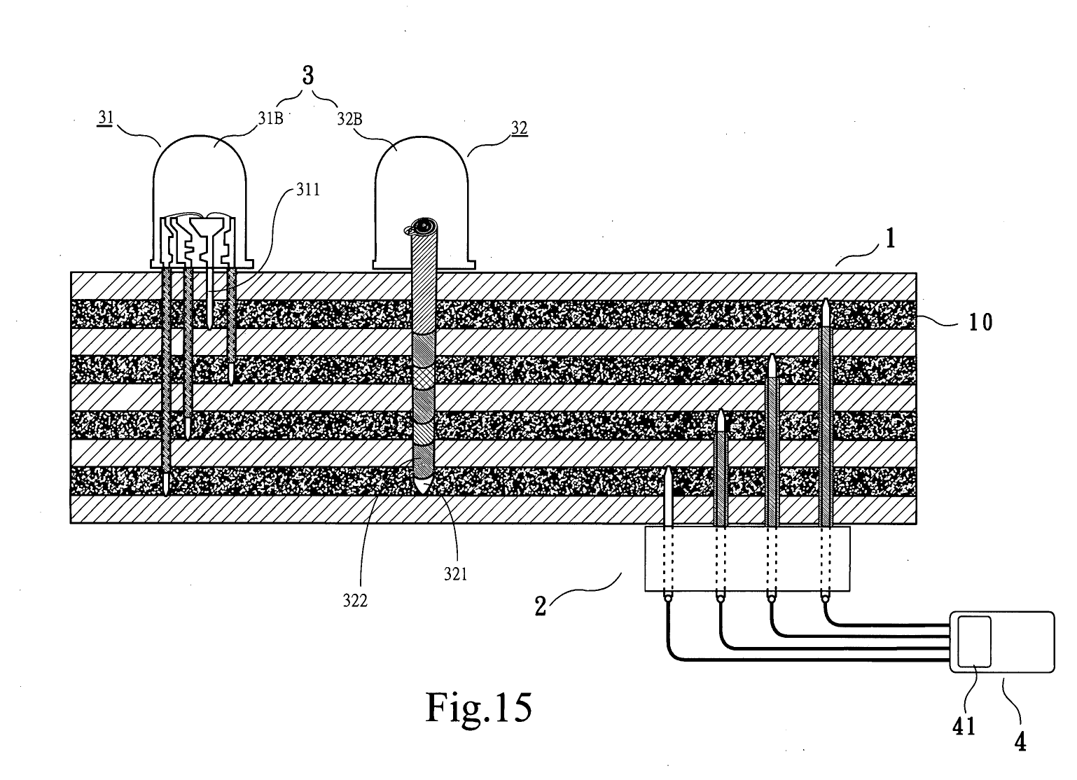

The first type LED (31) of the embodiment can also function with the assembling substrate (1) having more than three conductive layers (10). As shown in FIGS. 14A, 14B and 15, first type LEDs (31) with different standard can be disposed on a same assembling substrate (1) which has 4 conductive layers (10) and each layer is provided with power of different voltage. When a first type LED (31) is plugged into the assembling substrate (1), all leads will connect with appropriate conductive layer (10) and receive suitable power supply.

Furthermore, the power source (4) can also connect with a control device (41) to provide each conductive layer (10) with synchronous or asynchronous power supply, permitting LED (3) having more illuminating effect.

Said assembling substrate (1) having more than 3 conductive layers (10) can also be connected with same standard of power source (4) for connection of LEDs (3) with same standard.

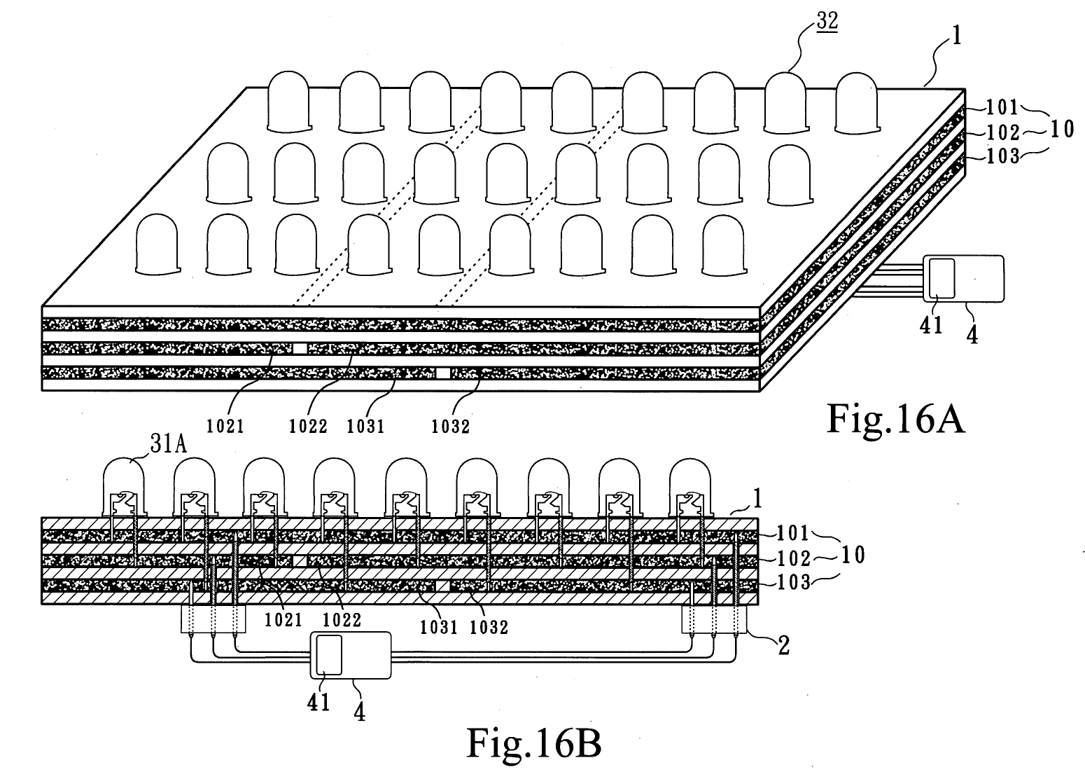

As shown in FIGS. 16A and 16B, a conductive layer (10) of the assembling substrate (1) can be divided into plurality of independent section; the second conductive layer (102) is divided into a primary section of second conductive layer (1021) and a secondary section of second conductive layer (1022), the third conductive layer (103) will be divided into a primary section of third conductive layer (1031) and a secondary section of third conductive layer (1032) with the function of the first conductive layer (101), said assembling substrate (1) can provides 4 different standards of power supply for 4 different standards of LED (3), the connection and control is the same as assembling substrate (1) having more than 3 conductive layers (10) connected with different power supply. Therefore, no more description will be described below.

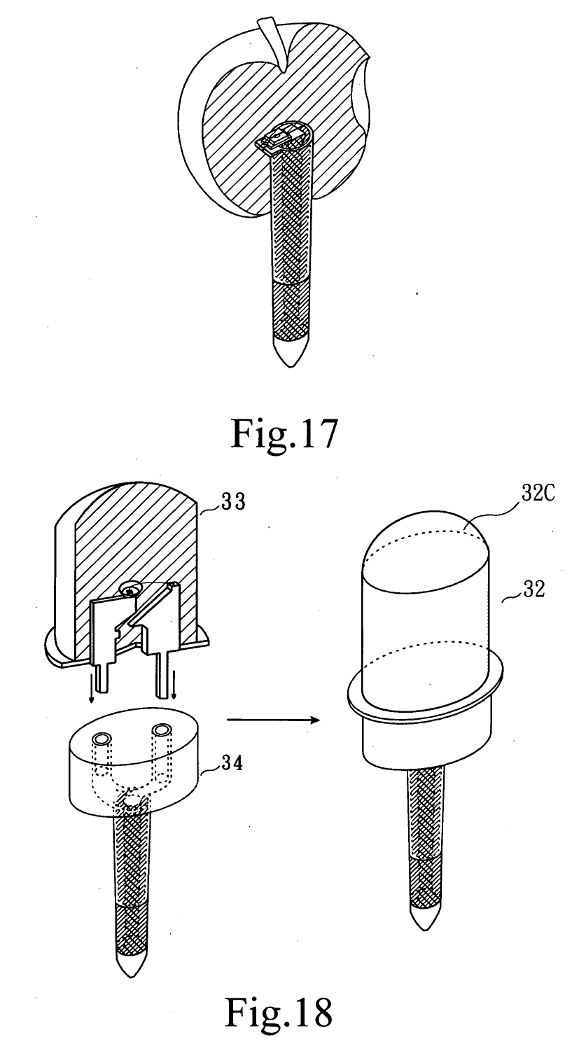

In FIG. 17, showing the shape of LED encapsulation can be manufactured as traditional cylindrical encapsulation, it also can be manufactured as other specific shape such as figure, letter or number.

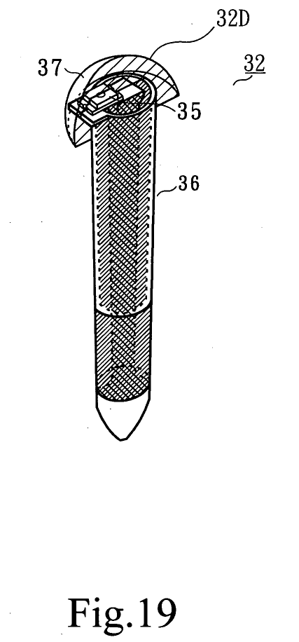

In FIG. 18, showing an alternative single-pin LED (32C), said alternative single-pin LED (32C) is formed by plugging a conventional LED (33) into a single-pin adapter (34). An alternative single-pin SMD LED (32D), as shown in FIG. 19, can also be form with same method by plugging a SMD LED (35) into a single-pin SMD adapter (36). Moreover, a light shield (37) can be disposed on top of said SMD LED (35) and fixed with said single-pin SMD adapter (36). When a light-guiding shield is selected as the light shield (37), the light-guiding ability will intensify the light emitted from said alternative single-pin SMD LED (32D), increasing the brightness of the light; and when a diffuser is selected as the light shield (37), the color of the light will be emitted more uniformly by diffusion.

An alternative single-pin/multi-poles LED (not shown) can also be applied according the above description, by jointing a multi-leads LED (31B) with a single-pin/multi-poles adapter (not shown), the single-pin conductive section and single-pin insulated section of said single-pin/multi-poles adapter are arranged in sandwich-like structure and match the arrangement of conductive layer (10) and non-conductive layer (11) of the assemble substrate (1)

It is preferable to have the first conductive layer (101) as ground or cathode and conductive layer (10) close to the LED (3) is provided with power supply having low voltage to increase the safety of unplugging a LED (3) when conductive layer (10) possesses electricity.

The power connector can also be utilized to connect between one assembling substrate (1) with another.

### CONCLUSION

Embodiment of the present invention as disclosed above provides an easy-to-assembly method to install/uninstall LED on a substrate with no wiring or welding procedure required, coupled with design of assembling substrate (1) having sandwich-like structure of conductive layers (10) and non-conductive layer (11), it allows LEDs of same or different standards can be disposed and lighted on the same substrate. Its abilities of fast-assembly, simple maintenance may increase the economic value and popularization of the LED with lower cost.

What are disclosed above are only the preferred embodiments of the present invention and it is therefore not intended that the present invention be limited to particular embodiments disclosed. It will be understood by those skilled in the art that various equivalent changes may be made depending on specification and drawings of present invention without departing from the scope of the present invention.

What is claim claimed:

1. An easy-to-assembly LED and substrate comprising:
an assembling substrate (1) having sandwich structure consisting essentially of a plurality of conductive layers (10) and a plurality of non-conductive layers (11);
a plurality of LED (3) having at least one lead partially insulated, all conductive and insulated sections of said LED (3) will correspond to the arrangement of the conductive layers (10) and non-conductive layers (11) of said assembling substrate (1); and
a power source (4).

2. An easy-to-assembly LED and substrate of claim 1 wherein the assembling substrate (1) characterized in that having sandwich structure, consisting essentially of a plurality conductive layer (10) and a plurality of non-conductive layer (11) is for installing the LED (3), the plurality of conductive layer (10) are for connecting the lead of LED (3) with the power source (4) which can be made of metal net, aluminum foil or conductive fabric, said non-conductive layers (11) can be made of insulating foam, rubber foam or rubber.

3. An easy-to-assembly LED and substrate of claim 1 wherein said LED (3) can be an first type LED (31) or a second type LED (32), both types have at least one lead partially insulated.

4. An easy-to-assembly LED and substrate of claim 3 wherein the insulation process can be made by applying an insulated treatment over the lead for the first type LED (31) and encapsulation molding or an adapter for the second type LED (32).

5. An easy-to-assembly LED and substrate of claim 3 wherein said first type LED (31) is characterized in that each lead has different length and only the first conductive layer lead (311) can be non-insulated, others leads are partially insulated;

6. An easy-to-assembly LED and substrate of claim 3 wherein said second type LED (32) is characterized in that both single-pin conductive section (321) and single-pin insulated section (322) are arranged in sandwich structure to match the arrangement of conductive layers (10) and non-conductive layers (11) of the assemble substrate (1);

7. An easy-to-assembly LED and substrate of claim 1 wherein the epoxy encapsulation of said LED (3) can have a shape of a typical cylindrical encapsulation or any irregular shape such as letter, figure or number;

8. An easy-to-assembly LED and substrate of claim 1 wherein said power source (4) can connect electrically to the assembling substrate (1) through a power connector (2) having same functional character as the LED (3) which the conductive and insulated lead of said power connector (2) will match the arrangement of conductive layer (10) and non-conductive layer (11) of the assembling substrate (1);

9. An easy-to-assembly LED and substrate of claim 1 wherein each conductive layer (10) of said assembling substrate (1) can have a single section or divided into plurality of independent sections, provided with same or different standards of power source (4).

10. An easy-to-assembly LED and substrate of claim 1 wherein said assembling substrate (1) can be made into any shape or a specific shape to coupled with the surface of a product; it can also be jointed to a product by being the primary material.

11. An easy-to-assembly LED and substrate of claim 8 wherein said power connector (2) can provide electrical connections between said power source (4) and said assembling substrate (1) or between two assembling substrates (1);

12. An easy-to-assembly LED and substrate of claim 3 wherein said first type LED (31) can be a dual-leads LED (31A) having a first conductive layer lead (311) not insulated and another lead partially insulated.

13. An easy-to-assembly LED and substrate of claim 3 wherein said first type LED (31) can be a multi-leads LED (31B) having all leads partially insulated except the first conductive layer lead (311)

14. An easy-to-assembly LED and substrate of claim 3 wherein said second type LED (32) can be a single-pin/dual-poles LED (32A) having its single-pin conductive section (321) and single-pin insulated section (322) in sandwich-like arrangement and match the arrangement of conductive layer (10) and non-conductive layer (11) of the assembling substrate (1)

15. An easy-to-assembly LED and substrate of claim 3 wherein said second type LED (32) can be a single-pin/multi-poles LED (32B) having its single-pin conductive section (321) and single-pin insulated section (322) in sandwich-like arrangement and match the arrangement of conductive layer (10) and non-conductive layer (11) of the assembling substrate (1).

16. An easy-to-assembly LED and substrate of claim 3 wherein said second type LED (32) can be an alternative single-pin LED (32C) formed by connecting a conventional lead LED (33) with a single-pin/dual-poles adapter (34), the single-pin conductive section (321) and single-pin insulated section (322) of said single-pin/dual-poles adapter (34) are arranged in sandwich-like structure and match the arrangement of conductive layer (10) and non-conductive layer (11) of the assembling substrate (1).

17. An easy-to-assembly LED and substrate of claim 3 wherein said second type LED (32) can be a single-pin SMD LED (32D), consisting essentially of a single-pin SMD adapter (36), a light shield (37) disposed on top of said single-pin SMD adapter (36) and a SMD LED (35) disposed between said single-pin SMD adapter (36) and light shield (37); the conductive and insulated portion of said single-pin SMD adapter (36) have a sandwich-like structure and match the arrangement of conductive layer (10) and non-conductive layer (11) of the assemble substrate (1).

18. An easy-to-assembly LED and substrate of claim 3 wherein said second type LED (32) can be an alternative single-pin/multi-poles LED, consisting essentially of a multi-leads LED (31B) with a single-pin/multi-poles adapter, the single-pin conductive section and single-pin insulated section of said single-pin/multi-poles adapter are arranged in sandwich-like structure to match the arrangement of conductive layer (10) and non-conductive layer (11) of the assemble substrate (1).
